(19) United States
(12) Patent Application Publication
(10) Pub. No.: US 2006/0112317 A1
(43) Pub. Date: May 25, 2006

(54) Method and system for managing information technology systems

(76) Inventors: Claudio Bartolini, Menlo Park, CA (US); Mathias Jean Rene Salle, San Francisco, CA (US); Christopher William Preist, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/983,155

(22) Filed: Nov. 5, 2004

(51) Int. Cl. G06F 11/00

(52) U.S. Cl. 714/47

(57) ABSTRACT

Embodiments in accordance with the present invention include methods and systems for managing information technology systems. A method includes monitoring, with a computer system, service operations of a service provider; detecting, with the computer system, a failure; diagnosing, with the computer system, the failure to determine a cause of the failure; and analyzing, with the computer system, the cause to determine a cost-based analysis to remedy the cause of the failure, the cost-based analysis including (i) terms and conditions specified in plural Service Level Agreements (SLAs) between the service provider and customers and (ii) both tangible and intangible costs to the service provider to remedy the cause of the failure.

### BACKGROUND

An organization may utilize information technology (IT) to perform a variety of organizational tasks, such as providing data storage, facilitating communication, and automating services. An organization's IT infrastructure of computer systems, networks, databases, and software applications may be responsible for accomplishing these organizational tasks.

The organizational tasks may, in part, be tied to or governed by terms and conditions stipulated in contracts and service level agreements (SLA). In general, a SLA is an agreement between two entities, such as a telecommunication entity or IT entity and a customer. The agreement specifies services that the entity will provide the customer and the terms and conditions involved with such services. For example, an SLA could define parameters such as the type of service being provided, data rates, penalties/rewards, and expected performance levels in terms of error rates, delays, port availability, response time, repair, etc.

When a component of the IT infrastructure degrades or becomes faulty, the performance of services that depend upon the component may be adversely affected. To remedy this performance degradation, a decision-maker, such as an IT manager, may be presented with several business-related decisions. For example, one such decision may be whether to repair or replace the faulty component. Each decision may be associated with one or more plans, such as to replace the component today or repair the component next week when a technician is available.

The decision-maker may analyze each decision by determining the projected utility gain or loss associated with performing each plan. In some instances, the utility may be dependent on the terms and conditions stipulated in a SLA or other type of contractual agreement that the organization has formed with various parties, such as customers, suppliers, and distributors. Unfortunately, management tools operated by the decision-maker may not integrate or fully consider the terms and conditions stipulated in SLAs when making such business-related decisions. A lack of appreciation for the contractual terms can reduce effectiveness of utility calculations and hinder the decision-maker from making truly informed decisions.

### SUMMARY

Embodiments in accordance with the present invention are directed to a method, apparatus, and system for managing information technology systems. A method includes monitoring, with a computer system, service operations of a service provider; detecting, with the computer system, a failure; diagnosing, with the computer system, the failure to determine a cause of the failure; and analyzing, with the computer system, the cause to determine a cost-based analysis to remedy the cause of the failure, the cost-based analysis including (i) terms and conditions specified in plural Service Level Agreements (SLAs) between the service provider and customers and (ii) both tangible and intangible costs to the service provider to remedy the cause of the failure.

Other embodiments and variations of these embodiments are shown and taught in the accompanying drawings and detailed description.

### BRIEF DESCRIPTION OF THE DRAWINGS

FIG. 1 illustrates an exemplary data processing network in accordance with an embodiment of the present invention.

FIG. 2 illustrates objective classes of a contract model.

FIG. 3 illustrates objective classes of an undertaking model.

FIG. 4 illustrates objective classes of a Service Level Agreement (SLA) model.

FIG. 5 illustrates object classes of a Service Level Objective (SLO) model.

FIG. 6 illustrates an IT management system in accordance with embodiments of the present invention.

### DETAILED DESCRIPTION

As used herein, a contract is a binding agreement between two or more persons, parties, and/or entities. A service level agreement (SLA) is an example of a contract. A SLA is an agreement between a customer or user and an entity, such as a service provider. The SLA, for example, can stipulate and commit the entity to provide the user with a required level of service. A SLA can contain various terms and condition, such as a specified level of service, support options, enforcement or penalty provisions for services not provided, a guaranteed level of system performance as related to downtime or uptime, a specified level of customer support, software or hardware for a specified fee, to name a few examples. The service provider can be, for example, an application service provider (ASP). An ASP manages and distributes software-based services and solutions from a central data center to customers across a network (such as a wide area network (WAN)).

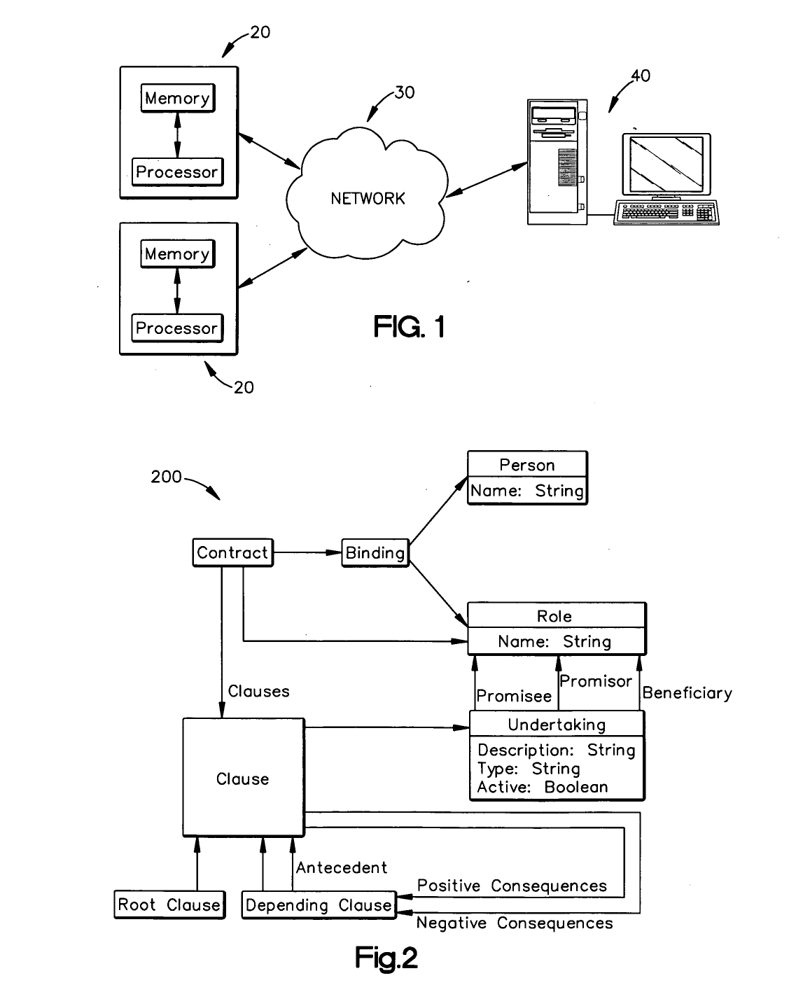

FIG. 1 illustrates an exemplary system or data processing network in which an embodiment in accordance with the present invention may be practiced. The data processing network includes a plurality of computing devices 20 in communication with a network 30 that is in communication with a computer system or server 40.

By way of example, the data processing network can be an IT infrastructure that comprises the computer systems, networks, databases, and software applications that are responsible for performing information processing. The IT infrastructure can use computers and software to convert, store, protect, process, transmit, retrieve, monitor, and analyze information and communications.

For convenience of illustration, only a few computing devices 20 are illustrated. The computing devices include a processor, memory, and bus interconnecting various components. Embodiments in accordance with the present invention are not limited to any particular type of computing device since various portable and non-portable computers and/or electronic devices may be utilized. Exemplary computing devices include, but are not limited to, computers (portable and non-portable), laptops, notebooks, personal digital assistants (PDAs), tablet PCs, handheld and palm top electronic devices, compact disc players, portable digital video disk players, radios, cellular communication devices (such as cellular telephones), televisions, and other electronic devices and systems whether such devices and systems are portable or non-portable.

The network 30 is not limited to any particular type of network or networks. The network 30, for example, can include a local area network (LAN), a wide area network (WAN), and/or the internet or intranet, to name a few examples. Further, the computer system 40 is not limited to any particular type of computer or computer system. The computer system 40 may include personal computers, mainframe computers, servers, gateway computers, and application servers, to name a few examples.

Those skilled in the art will appreciate that the computing devices 20 and computer system 40 may connect to each other and/or the network 30 with various configurations. Examples of these configurations include, but are not limited to, wireline connections or wireless connections utilizing various media such as modems, cable connections, telephone lines, DSL, satellite, LAN cards, and cellular modems, just to name a few examples. Further, the connections can employ various protocol known to those skilled in the art, such as the Transmission Control Protocol/Internet Protocol (“TCP/IP”) over a number of alternative connection media, such as cellular phone, radio frequency networks, satellite networks, etc. or UDP (User Datagram Protocol) over IP, Frame Relay, ISDN (Integrated Services Digital Network), PSTN (Public Switched Telephone Network), just to name a few examples. Many other types of digital communication networks are also applicable. Such networks include, but are not limited to, a digital telephony network, a digital television network, or a digital cable network, to name a few examples. Further yet, although FIG. 1 shows one exemplary data processing network, embodiments in accordance with the present invention can utilize various computer/network architectures. Various alternatives for connecting servers, computers, and networks will not be described as such alternatives are known in the art.

The data processing network can include one or more databases (such as a database in conjunction with computer system 40) for storing information. This information, for example, can include contract data related to an organization's contractual agreements (including the actual terms and condition in a contract). Such contractual agreements include SLAs that are associated with particular SLOs. The SLAs can define minimum service levels for particular groups of customers and penalties if the service level falls below agreed upon values for the group. As another example, this information may include customer data related to an organization's customers. Such information can include behavioral models based on past behavior of a customer group and other identifying information related to the customers of the organization. As another example, this information may include service data relating to an organization's IT services, such as email, network provisioning, online shops, or other IT services. Such information may include scheduling policies, current and/or predicted demand and costs associated with the services. As yet another example, this information may include resource data relating to an organization's resources, such as computer servers, systems, and applications. The resources may be utilized to operate the IT services. Such information includes current availability of resources, the projected availability of resources, and costs associated with the resources.

In embodiments in accordance with the invention, methods and systems are utilized to manage and analyze information technology (IT) systems and conduct a cost analysis to cure or remedy IT failures or violations. The cost analysis is based, in part, on cost and utility information that is extracted from the terms and conditions in electronic contracts, such as SLAs. The figures are provided as an illustration and should not be used to limit, for example, various ways to manage IT systems and provide cost analyses based on information contained in contracts.

FIG. 2 illustrates objective classes of a contract model 200. As shown, the contract model consists of a collection of clauses. Each clause states an undertaking that is promised, and the consequences of meeting and not meeting the undertaking. Consequences, in turn, take the form of clauses. The contract also contains a collection of bindings between roles in the contract and the actual persons that play them. Examples of roles are buyer, service provider, etc.

Because of the dynamic nature of the business interactions in contracts model, not all the undertakings that are specified in a contract are active at a given time. Some undertakings, for example, become active as time progresses, while other undertakings never become active, as in the case of penalties that never materialize.

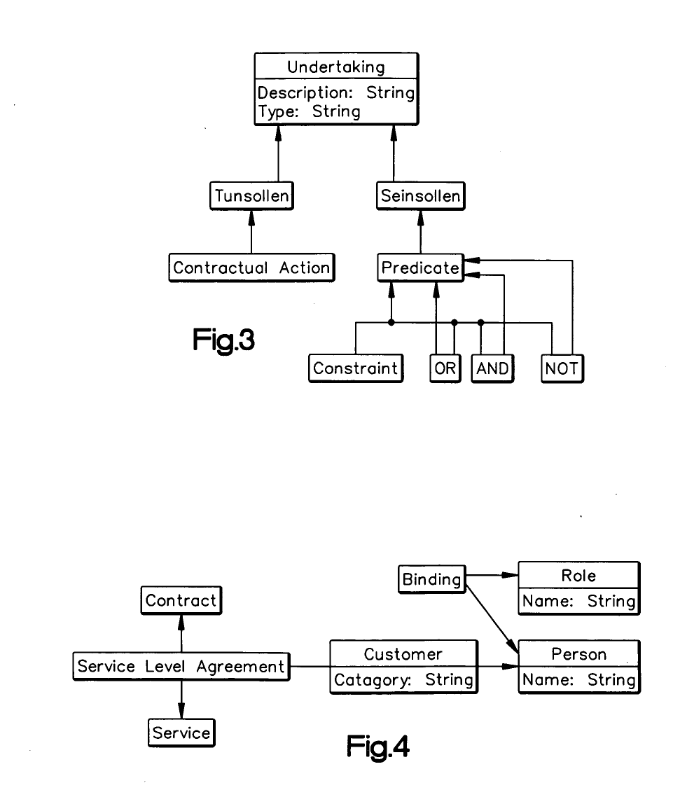

FIG. 3 illustrates objective classes of the undertaking model. Here, the undertakings are characterized by specific roles: promisor, promisee and beneficiary. The promisor is the role manifesting the intention; the promisee is the role to whom the promise is addressed; the beneficiary is the role other than the promisee that benefits from the performance of the intention. Further, two different kinds of undertakings exist: promises of bringing about a certain state of affairs (a “seinsollen” or “ought-to-be” undertaking) and promises of carrying out a certain contractual action (a “tunsollen” or “ought-to-do” undertaking). A seinsollen undertaking specifies the state that is promised to be brought about through a predicate. A tunsollen undertaking specifies the action that is promised to be carried out.

Contracts can be defined over a wide range of services. For purposes of illustration, a contract model will be discussed as a SLA model that provides warranties over some parameters of a given service, penalties for not meeting the warranties, and possible rewards for exceeding the warranties. Thus, the contract model can capture dependency relationships (positive and negative consequences) that exist between clauses within a contract. Also, in order to derive utility from the analysis of these contracts, the model must adequately capture penalties and rewards.

FIG. 4 illustrates a SLA model with object classes. The SLA model specifies the customer to which the SLA refers from the point of view of the user or contract management system. This information is instantiated by looking through the binding of the SLA and extracting, for example, the person or entity representing the user's counterpart in the SLA seen as a contract. Further, the SLA is defined over a service.

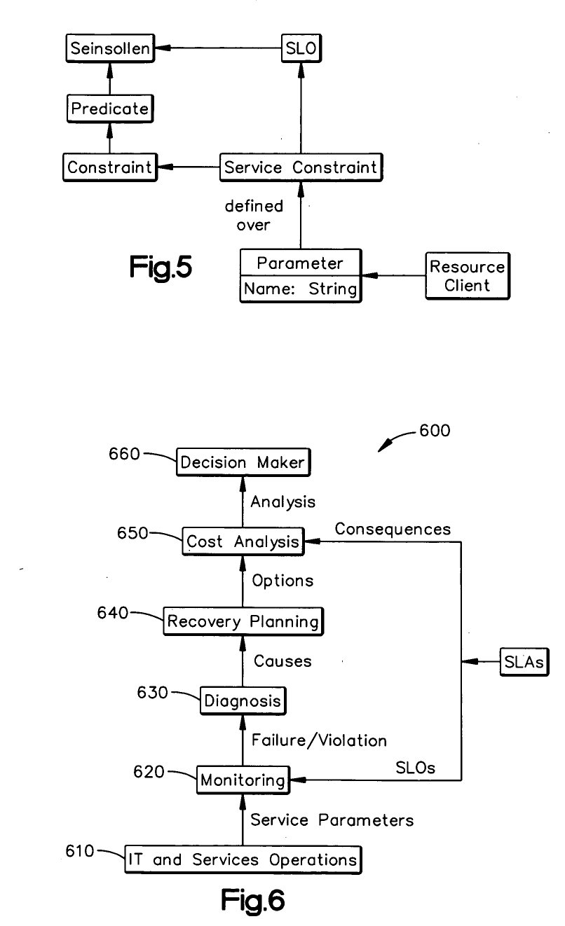

FIG. 5 illustrates the object classes of a Service Level Objective (SLO) model. The SLOs are modeled as seinsollen undertakings containing a predicate of type ServiceConstraints defined over ResourceClient parameters. By way of illustration, a ResourceClient models any kind of apparatus that possesses descriptive parameters and that uses resources (such as information technology resources); it can be a system, a process, an application, a service or business process, etc.

During modeling or building of the contract, numerous terms and conditions are defined, such as the costs and penalties. As an example, consider modeling of a SLA. The SLA may include concrete parameters that define when a service provider or customer is failing to meet a term or condition. For example, a parameter may state that the service provider is in failure or breach if the network fails to be available 99.5% of the time. Breaching terms or conditions of the service agreement have associated costs (such as penalties for one party and rewards for another party). The penalties and rewards may be defined in the SLA. For instance, a service provider might be willing to refund 10% of a monthly access fee for availability degradation of 10% or less. In another SLA, a service provider might be forced to upgrade the disk drives for a disk space degradation of 20% or more. Further, the penalties and costs are built into the varying level SLAs. For instance, a service provider might agree that the monthly fee for a gold-level SLA is $1000, which provides for a specific level of performance. Once all of the terms and conditions (example, parameters, components, SLA types, triggers, penalties/costs, etc.) are defined, an SLA can be built or created for a specific customer.

FIG. 6 illustrates an IT management system 600. For illustration purposes, this system is described as an IT management system utilizing SLAs. The IT management system is illustrated in a management stack having numerous blocks or layers. The management system can be utilized to perform a variety of managerial services. For example, a service provider or entity can use the management system to monitor IT and service operations, monitor and/or analyze SLAs and accompanying terms and conditions (example, parameters, levels of quality of service (QoS), and SLOs), report compliance and violations, issue alarms and other notifications, and provide recommendations to minimize costs to the service provider in the event of an IT problem, such as a failure or non-compliance.

The IT management system 600 can conduct a cost analysis to cure or remedy IT failures or violations and present this cost analysis to a decision-maker. The cost analysis is based, in part, on cost and utility information that is extracted from the terms and conditions in electronic contracts, such as SLAs. For example, when a component of an IT infrastructure degrades, needs upgraded, or becomes faulty, the performance of services that depend upon the particular component may be adversely affected. The IT management system can extract information (such as terms and conditions) from SLAs and use this information to provide various recommendations, courses of action, or options to the decision-maker for remedying the particular IT problem. In order to remedy a failure or violation, for instance, one or more courses of action may be available to the decision-maker. The utility gains and losses to the service provider for each of these courses of action may be dependent on the terms and conditions stipulated in one or more SLAs or other type of contractual agreements that the service provider has formed with various parties, such as customers, suppliers, and distributors. The IT management system analyzes the terms and conditions in SLAs pertaining to the IT problem to project utility gains and losses associated with each course of action. The proposed courses of action, thus, include factors from the terms and conditions stipulated in relevant SLAs.

Block 610 includes information technology (IT) and services operations of the entity or service provider. The service parameters are communicated from the IT and Services Operations to the Monitoring Layer, block 620. Thus, the various terms and conditions associated with the SLAs agreed upon between the service provider and customers are provided. The terms and conditions include the parameters, SLO, quality of services (QoS), etc. that define each SLA.

Per block 620, the Monitoring Layer monitors service operations of the service provider. For example, this layer can monitor the various terms and conditions of the SLAs and probe the liveliness of the IT systems and particular systems or service parameters. This layer can, for example, monitor the operations of the IT system or systems and monitor whether the terms and conditions of the SLA are being satisfied. The actual parameters being monitored in the SLA will depend on the terms and conditions of the SLA. For example, a system having a particular database might require measurements for throughput or transaction times to determine compliance. Further, an instantiation of an SLA model can define measurements that are required for the specific-level SLA. For instance, at the silver-level SLA, transaction time may be measured, but at the gold-level, both transaction time and available disk space may be measured.

In the event of a failure, the monitor would detect the failure and notify the service provider and/or customer. If the failure impacted other services, then a list of impacted services could be determined and a notification sent to the service provider. For example, an alarm could be sent to the service provider if the monitoring layer discovers measurements of service parameters violate thresholds established in a SLA.

The Monitoring Layer can monitor for and detect the occurrence of a wide range of failures or violations. By way of example, such failures include non-compliance (example, by a customer with respect to terms and conditions in a SLA), faults (example, a server of the service provider fails), violations of a SLAs (example, violation on the part of the service provider or the customer), and degradations.

Each specific-level SLA will have a set of requirements that must be met in order to be in compliance. For instance, for SLAs related to database systems, a transaction time or throughput measurement can be a requirement. Various level SLAs can have a different trigger, or threshold, defined for a given measurement type. These triggers are input and defined in the contract management system. For example, measurements for a SLA can include throughput, disk space and availability. Different level SLAs will have different triggers/thresholds. For instance, a gold-level SLA might require 99.5% availability, while a platinum-level SLA might require 99.9% availability.

Another aspect of defining triggers is to define a method or means of notification when the threshold is exceeded. For example, the trigger can be defined as the notification point, and the threshold can be defined as the non-compliance point. An e-mail, fax, or pager notification could be sent when the threshold is approached. Further, different warnings (such as a low, medium and high) can be utilized for varying non-compliance thresholds. Further yet, alarms, failures, violations, etc. may be reported directly to the Decision Maker (block 660) or used as input to the Diagnosis Layer.

In block 630, the Diagnosis Layer receives failure or violation events from the Monitoring Layer. The Diagnosis Layer identifies the cause of the failure or violation. The cause or causes may be reported directly to the Decision Maker (block 660) or used as input to the Recovery Planning Layer, per block 640.

The Recovery Planning Layer analyzes the input cause(s) and determines recovery plans for the input cause(s). As a result of this analysis, a single option or multiple options are determined. These options describe the recovery plans and associated costs are determined. Further, the options can be reported directly to the Decision Maker (block 660) or used as input to the Cost Analysis Layer, per block 650.

The Cost Analysis Layer provides a cost-based analysis for curing or remedying the cause(s) of the failure(s) or violation(s). Based on an analysis of the terms and conditions within the SLAs and other factors, the Cost Analysis Layer associates a utility value to each of the options. This utility reflects an overall impact that a recovery option would have on the use of the services impacted. The Cost Analysis Layer analyzes the consequences and costs of violating or complying with the various terms and conditions (example, various service level objectives (SLO)) stated in the SLAs.

Per block 660, analysis from the Cost Analysis Layer is directed to the Decision Maker Layer. This analysis can be provided in numerous different formats. For example, the analysis can include a recovery plan to cure or minimize consequences of the failure or violation. Further, the analysis can include a recommendation based on an optimal or efficient cost to the service provider. Further yet, consequences and costs associated with each option can be presented to the decision maker.

Given a set of SLAs and a set of options (example, options presented from the Recovery Planning Layer at 640), the Cost Analysis Layer analyzes the set of options and determines which option or options have the least impact on the service provider and/or the business relationships between the service provider and the customers.

In the Cost Analysis Layer, the analysis of the options can include various factors. For example, these factors can include various costs to the service provider, such as actual costs (including tangible costs) and intangible costs.

The actual costs are the costs (example, in dollars) to the service provider of implementing an option. Actual costs include all tangible or quantifiable costs to the service provider or entity. For example, the actual costs include the costs of curing or repairing the violation, new equipment, loss of revenue, repairing or servicing the failed equipment, payments to employees or contractors working on the failure, rental or leased equipment to subsidize the failed equipment, parts, etc.

A subset of the actual costs includes the contractual costs. The contractual costs are the costs to the service provider per the terms and conditions in the contract. The contractual costs are derived from the contract or SLA itself. For example, these costs might include fees and penalties imposed, by terms and conditions in the contract or SLA, on the service provider for a violation or for failing to meet a specified condition.

The actual and contractual costs are tangible and/or quantifiable costs. As used herein, tangible means capable of being perceived, capable of being precisely identified or realized, or capable of being appraised at an actual or approximate value. As used herein, quantifiable or quantify means to limit by a quantifier (i.e., a prefixed operator that binds the variables in a logical formula by specifying their quantity or a limiting noun modifier (as five in “five dollars”) expressive of quantity and characterized by occurrence before the descriptive adjectives in a noun phrase), to bind by prefixing a quantifier, to make explicit the logical quantity of, or to determine, express, or measure the quantity of.

As noted, the Cost Analysis Layer can also include intangible costs and/or non-quantifiable costs. As used herein, intangible means not tangible, and non-quantifiable means not quantifiable.

Intangible costs, even though not quantifiable, can impact the overall costs to the service provider. As such, the Cost Analysis Layer can acknowledge and factor into the analysis calculation such intangible costs. Examples of intangible costs are numerous and include, but are not limited to, goodwill between the service provider and customer, reduced productivity, reduction in strength of or harm to business relations, negative impact on future contracts, loss of future sales, weakened personal or business relations with customers, diminished morale, etc.

The Cost Analysis Layer can calculate the costs (tangible/quantifiable and/or intangible/non-quantifiable) in a variety of ways, and embodiments in accordance with the invention are not limited to a specific calculation for these costs. Examples in accordance with embodiments of the invention for calculating these costs are provided.

The contract utility can be calculated to determine or assess the value that a service provider or entity would perceive or realize based on the probability of the outcome occurring. Such an outcome could, for example, be the violation of a SLO. Thus, if the likelihood of a violation is low, the perceived utility will be higher than if the likelihood is high. Similarly if the associated penalty is a function of the violation, the outcome itself will influence the perceived utility.

From a utility point of view, a contract or a SLA can be viewed as network of clauses: a clause has positive and negative consequences that are themselves clauses. The contract utility of an undertaking v given its likelihood of violation λ, is given by:
u_{c}(v,λ)=(1−λ)(uᵥ+u₊)+λu₋
Here uᵥ is the direct utility of the undertaking v, u₊ is the utility of the positive consequences and u₋ is the utility of the negative consequences.

The contract utility can be utilized in a variety of embodiments. For illustration purposes only, suppose a service provider provides three different levels of service (Gold, Silver and Bronze) in a SLA. Each level of service has a different term and condition or service guarantee. For example, the service guarantees may govern the time between order and shipment as follows:
(1) Gold SLA: Time between order and shipment shall be less than 3 days; otherwise the cost of the order is fully refunded.
(2) Silver SLA: Time between order and shipment shall be less than 5 days; otherwise a refund of 10% of the cost of the order or $70, whichever is greater will be applied.
(3) Bronze SLA: Time between order and shipment shall be less than 10 days; otherwise $50 will be refunded.

In the Gold SLA, suppose an order worth $1000 of profit and an associated likelihood of violation of 0.2. In this scenario, the resulting contract utility would be:
(1−0.2)*1000+0.2*(−1000)=600

In a contract-base analysis, the outcome of the various options to assess can be computed. For each impacted service, a computation is made of the expected service level. This service level is characterized by the expected value of the relevant terms and conditions (example, parameters) of the service.

SLOs, for example, can be defined over service parameters. In turn, service parameters are expressed as functions of internal parameters (internal mapping). For instance, given a particular business flow, the service parameter Time to Delivery can be defined as the aggregate of the processing time for each node of the business flow. Internal parameters are themselves characterized by the availability of the underlying resources, such as IT resources. For instance, the expected time of execution at a generic processing node can be characterize in terms of availability. This forecast is referred to as Resource Availability Profile (RAP).

Given an option and a scheduling policy, the associated service level for an impacted service can be computed by determining or calculating the availability of resources using the RAP and the relevant service parameter values using the internal mapping functions. Once the service level is determined, the associated likelihood of violation can be computed.

SLOs can take the form of threshold constraints over the values of service parameters. Given a forecasted service parameter value pfv˜N(μ_{f}σ_{f}) and a threshold tv˜N(μₜσₜ), the likelihood of violation can be computed. In other words, the probability that pfv>tv or pfv<tv can be calculated, depending on the constraint operator. Under the assumption that pfv and tv are independent, this is equivalent to computing the probability that a variable with normal distribution is less (greater) than 0. This results in λ, the likelihood of violation of the SLO.

For illustration purposes, an algorithm is presented that exemplifies how various steps of a contract-based analysis can be executed. The algorithm assumes a set ◯ of options, a set S of scheduling policies, a set RC of impacted resource clients, and suppose a workload Wrc associated to each impacted resource client rc in RC. The algorithm further assumes that for each impacted SLO we have its associated likelihood of violation λₛₗₒ.

Begin

Determine the set iSLO of impacted SLO
For each Option o in O

For each Scheduling Policy s in S
For each ResourceClient rc in RC impacted

Compute new workload NWrc by applying s to initial workload Wrc
For each request r in NWrc

For each slo in iSLO

Compute u(o, s, rc, r, slo, λₛₗₒ) = u_{c}(r, slo, μ_{slo) + u}ₛ (r, slo, λₛₗₒ)

End
$Compute u ( o , s , rc , r ) = {\sum }_{slo ∈ iSLO} u ( o , s , rc , r , slo , {λ}_{slo} ) + {u}_{s} ( r )$

End
$Compute u ( o , s , rc ) = {\sum }_{r ∈ NWrc} u ( o , s , rc , r ) + {u}_{s} ( o , s , rc )$

End
$Compute u ( o , s , ) = {\sum }_{rc ∈ RC} u ( o , s , rc ) + {u}_{imp} ( o , s )$
Add u(o, s) to the utility set U
End

End

End

In this algorithm, the following notations are utilized:
u(o,s,rc,r,slo,λₛₗₒ) denotes the utility of a request r associated to a resource client rc computed for a particular SLO and its likelihood of violation λₛₗₒ given a specific option o and a scheduling policy s.
u(o,s,rc,r) denotes the contract utility of a request r associated to a resource client rc given a specific option o and a scheduling policy s.
u(o,s,rc) denotes the contract utility associated with a resource client rc given a specific option o and a scheduling policy s.
u(o,s) denotes the contract utility associated with a specific option o and a scheduling policy s.
u_{c}(r,slo,λₛₗₒ) denotes the contract utility associated with a particular request r given an SLO and its likelihood of violation.
uₛ(r,slo,λₛₗₒ) denotes the SLO strategic utility.

uₛ(r) denotes the customer utility, uₛ(rc) denotes the enterprise utility.
uᵢₘₚ(o,s) denotes the utility associated with the cost of implementation of the option o and a scheduling policy s.
U is the utility set containing all the utilities u(o,s) computed so far.

This algorithm results in a set U of utilities u(o,s). To maximize the utility of the decision making, an exemplary recommendation is to adopt the option in U with the highest utility.

Estimating the utility of an option focusing solely on the contractual utility might lead to incomplete or inaccurate results since such results do not consider intangible or non-quantifiable costs and factors. As noted, such factors and costs can be included in the Cost Analysis Layer.

As noted, the intangible or non-quantifiable costs are factors are numerous, and examples are numerous. For illustration purposes, these costs and factors can be grouped as a strategic utility. The strategic utility can further be defined with three different utilities, namely (1) SLO strategic utility, (2) customer strategic utility, and (3) enterprise or entity strategic utility.

The SLO strategic utility captures the value of an outcome with regard to an objective defined as a SLO. For instance, all else being equal, an enterprise may tend to prefer to comply to a SLO with a strategic partner (example, high valued customer) rather than with a second-tier partner (example, a lower valued customer). In this case, contractual information alone may not be sufficient to evaluate the utility for a certain outcome; information beyond or outside the contract can be considered or taken into account to satisfy this utility. By way of example, such information includes the perceived strategic value of each partnership, and the damage that either would suffer because of the contractual breach.

The customer strategic utility focuses on the value of a particular outcome independently of the SLOs that are active at a given moment. For example, an enterprise could declare a strategic objective to always guarantee a certain degree of service availability to preferred customers, regardless of what SLOs are in place with the particular customer. In this scenario, information beyond or outside the contract can be considered or taken into account to consider this utility.

The enterprise strategic utility focuses on the objectives defined by the enterprise independently of its contractual relationships. For instance, an enterprise might commit to the strategic objective of delivering on time for 95% or more of the orders.

In the various embodiments in accordance with the present invention, embodiments are implemented as one or more computer software programs. The software may be implemented as one or more modules (also referred to as code subroutines, or “objects” in object-oriented programming). The location of the software (whether on the client computer or elsewhere) will differ for the various alternative embodiments. The software programming code, for example, can be accessed by the processor of the computing device 20 and computer system 40 from long-term storage media of some type, such as a CD-ROM drive or hard drive. The software programming code may be embodied or stored on any of a variety of known media for use with a data processing system or in any memory device such as semiconductor, magnetic and optical devices, including a disk, hard drive, CD-ROM, ROM, etc. The code may be distributed on such media, or may be distributed to users from the memory or storage of one computer system over a network of some type to other computer systems for use by users of such other systems. Alternatively, the programming code may be embodied in the memory, and accessed by the processor using the bus. The techniques and methods for embodying software programming code in memory, on physical media, and/or distributing software code via networks are well known and will not be further discussed herein.

The flow diagrams and figures should not be strictly construed as limiting embodiments in accordance with the present invention. One skilled in the art will appreciate that the flow diagrams may be combined and/or rearranged with no loss of generality, and procedural steps or blocks may be added, subtracted, altered, and/or rearranged by one skilled in the art depending on the intended target application.

While the invention has been disclosed with respect to a limited number of embodiments, those skilled in the art will appreciate, upon reading this disclosure, numerous modifications and variations. It is intended that the appended claims cover such modifications and variations and fall within the true spirit and scope of the invention.

What is claimed is:

1) A method, comprising:
monitoring, with a computer system, service operations of a service provider;
detecting, with the computer system, a failure;
diagnosing, with the computer system, the failure to determine a cause of the failure; and
analyzing, with the computer system, the cause to determine a cost-based analysis to remedy the cause of the failure, the cost-based analysis including (i) terms and conditions specified in plural Service Level Agreements (SLAs) between the service provider and customers and (ii) both tangible and intangible costs to the service provider to remedy the cause of the failure.

2) The method of claim 1 wherein analyzing, with the computer system, the cause to determine a cost-based analysis further comprises calculating actual costs to the service provider for different options to remedy the cause of the failure.

3) The method of claim 2 wherein the actual costs include contractual costs per terms and conditions specified in the SLAs.

4) The method of claim 2 wherein analyzing, with the computer system, the cause to determine a cost-based analysis further comprises calculating fees and penalties imposed upon the service provider for failing to meet a parameter specified in a SLA.

5) The method of claim 1 wherein analyzing, with the computer system, the cause to determine a cost-based analysis further comprises calculating, for different options to remedy the cause of the failure, a value that the service provider would realize based on a probability of each different option occurring.

6) The method of claim 1 wherein analyzing, with the computer system, the cause to determine a cost-based analysis further comprises calculating a probability that different options will occur, wherein the different options remedy the cause of the failure.

7) A computer-readable medium having computer-readable program code embodied therein for causing a computer system to perform:
monitoring service operations of a service provider;
detecting a failure;
analyzing the failure to determine a cause of the failure; and
analyzing terms and conditions in a Service Level Agreement (SLA) between the service provider and a customer to compute both tangible and intangible costs to the service provider to remedy the cause of the failure.

8) The computer-readable medium of claim 7 for causing the computer system to further perform:
calculating plural options to remedy the cause of the failure;
presenting, to the service provider, the plural options.

9) The computer-readable medium of claim 7 for causing the computer system to further perform calculating an option to remedy the cause of the failure, wherein the option represents a lowest cost to the service provider.

10) The computer-readable medium of claim 7 wherein analyzing terms and conditions in the SLA further comprises calculating a value on an intangible cost that is derived from a Service Level Objective (SLO) in the SLA.

11) The computer-readable of claim 7 wherein analyzing terms and conditions in the SLA further comprises calculating a value on an intangible cost that is an objective by the service provider to provide a certain degree of service to a customer.

12) The computer-readable of claim 7 wherein analyzing terms and conditions in the SLA further comprises calculating a value on an intangible cost that is an objective defined by the service provider that is not included in the SLA.

13) The computer-readable of claim 7 wherein analyzing terms and conditions in the SLA further comprises calculating an intangible cost that is not included as a parameter in the SLA.

14) A computer system, comprising:
logic for monitoring, for a service provider, service operations in a network;
logic for detecting a failure;
logic for determining a cause of the failure;
logic for analyzing terms and conditions in a Service Level Agreement (SLA) between the service provider and a customer;
logic for analyzing both tangible and intangible costs to the service provider to cure the cause of the failure; and
logic for presenting at least one option to cure the cause of the failure.

15) The computer system of claim 14 further comprising logic for determining a probability of occurrence for the at least one option.

16) The computer system of claim 14 wherein the tangible costs include contractual costs per terms and conditions specified in the SLA and costs not included in the contractual costs.

17) The computer system of claim 14 wherein the tangible costs include fees and penalties imposed upon the service provider for failing to meet a parameter specified in the SLA.

18) The computer system of claim 14 wherein the tangible costs include actual costs for implementing the at least one option to cure the cause of the failure.

19) The computer system of claim 14 wherein the intangible costs include costs that are based on a Service Level Objective (SLO) in the SLA

20) The computer system of claim 14 wherein the intangible costs include goodwill between the service provider and the customer.
